(19) United States
(12) Patent Application Publication
(10) Pub. No.: US 2025/0389592 A1
(43) Pub. Date: Dec. 25, 2025

(54) Discerning Laser Radiation From Ambient Light System

(71) Applicant: Oren Aharon, Haifa (IL)

(72) Inventor: Oren Aharon, Haifa (IL)

(21) Appl. No.: 18/752,855

(22) Filed: Jun. 25, 2024

(51) Int. Cl. G01J 9/02; H01S 3/08

(52) U.S. Cl. CPC G01J 9/02; H01S 3/08004

(57) ABSTRACT

The present invention pertains to an apparatus and method designed to distinguish and characterize laser radiation amidst ambient light environments. This sensor is capable of detecting laser emissions and determining their directions. Utilizing the double-slit experiment, the apparatus exploits the coherence and directional properties inherent to laser light, contrasting sharply with the incoherent and omni-directional nature of ambient light. Laser radiation is monochromatic and coherent. When directed through a double slit, lasers produce a distinctive interference pattern on a sensing screen, marked by well-defined bright and dark fringes that are sharply separated due to laser coherence. Conversely, ambient light, comprising diverse wavelengths and phases, does not produce clear interference patterns and has a diffused distribution on the screen. In practical application, the sensor can utilize imaging devices such as CMOS cameras to sample and subtract the diffuse background produced by ambient light, thereby enhancing the detection and characterization of lasers.

### BACKGROUND OF THE INVENTION

### 1. Field of Invention

The invention focuses on optically detecting laser emissions and their directional alignment, particularly for applications like free-space communication, where precise alignment between the laser transmitter and receiver is crucial. Current methods for establishing and maintaining this alignment can be time-consuming, requiring meticulous adjustments. If communication is disrupted, re-aligning the system becomes necessary.

Our method addresses these challenges by promptly detecting misalignments in laser direction and facilitating realignment based on this information. This approach aims to streamline the alignment process, ensuring more efficient and reliable operation of free-space communication systems.

Moreover, since the shift in the interference pattern's center is directly proportional to the distance from the slits to the screen and the angle of incidence of the laser, we can easily calculate the laser direction relative to the sensor unit.

This method leverages the principles of coherence and interference, allowing for a straightforward visual distinction between laser light and ambient light based on the patterns observed on the screen. It provides a qualitative but effective means of identifying laser radiation in the presence of ambient light.

### 2. Description of the Related Art

The patent discusses innovations in laser detection systems that enhance the alignment of optical communication, focusing particularly on methods for swiftly and reliably detecting laser emissions and determining their direction. Emphasis is placed on achieving precise alignment and upkeep of free space optical links. Existing technologies utilize diverse approaches, including active tracking systems with servo mechanisms and motorized mounts, autonomous optical alignment systems integrating adaptive optics and image processing, and the use of GPS for initial alignment. Fine tracking sensors and feedback systems improve alignment accuracy, while laser pointing, and beacon signals facilitate initial alignment. Emerging technologies like software-defined networking (SDN) and machine learning enable automated management and predictive alignment adjustments. These advancements are geared towards optimizing the reliability and performance of optical communication links under varying environmental conditions. The system is designed to mitigate communication disruptions caused by challenging circumstances, swiftly detecting the angular direction of incoming laser beams, and readjusting the system to restore communication.

### SUMMARY

The patent introduces an apparatus and method designed to distinguish and characterize laser radiation amidst ambient light environments. It features a sensor capable of detecting laser emissions and determining their direction accurately. By utilizing the double-slit experiment, the device leverages laser light's coherence and directionality, contrasting with the diffuse and non-directional nature of ambient light.

Laser radiation exhibits monochromaticity, directionality, coherence, and intensity. When passed through a double slit, lasers create a distinctive interference pattern on a sensing screen, characterized by well-defined bright and dark fringes due to their coherence. In contrast, ambient light, comprising various wavelengths and phases, results in a diffuse distribution on the screen without clear interference patterns.

In practical applications, the sensor employs imaging devices like CMOS cameras to mitigate the diffuse background from ambient light, thereby enhancing the detection and characterization of laser emissions.

The invention focuses on optimizing optical communication alignment, particularly for applications requiring precise laser transmitter-receiver alignment, such as free-space communication. Current methods often involve time-consuming adjustments, and communication disruptions necessitate realignment. The patented method swiftly detects laser direction misalignments and facilitates prompt realignment, aiming to streamline the alignment process for more efficient and reliable free-space communication.

Overall, the technology capitalizes on coherence and interference principles to visually distinguish laser radiation from ambient light, offering a qualitative yet effective means of identifying laser emissions amidst varying environmental conditions.

To summarize, an apparatus for Discerning Laser Radiation from Ambient Light is disclosed and comprises of an opaque surface onto which a combination of laser radiation and ambient light is projected, a double-slit arrangement positioned on said opaque surface, a screen or imaging detector positioned at a predetermined distance from said double-slit arrangement, wherein the screen or imaging detector is configured to display an interference pattern for the laser radiation characterized by distinct peaks and valleys, and a diffuse pattern for the ambient light. For cases where ambient light is very significant, a method of enhancing the Signal-to-Noise Ratio between Laser Radiation and ambient light is proposed where projecting a combination of laser radiation and ambient light onto an opaque surface, directing the light through a double-slit arrangement, capturing the resulting interference and diffuse patterns on a screen or imaging detector, processing the captured image to subtract the average value of the ambient light, thereby enhancing the distinctness of the laser radiation peaks.

Based on this method and apparatus including the dispersive element consists of a dispersive element configured to separate incoming light into components based on wavelength, a double-slit screen positioned to receive the dispersed light, a screen or imaging detector configured to capture the interference pattern of the laser radiation and the spread-out pattern of the ambient light, wherein the dispersive element enhances the signal-to-noise ratio by spreading out the ambient light while maintaining the coherence of the laser radiation.

System for Detecting Laser Radiation in High Ambient Light Environments: A system for detecting laser radiation in high ambient light environments, comprising an opaque surface for receiving combined laser radiation and ambient light, a double-slit arrangement on the opaque surface, a dispersive element for separating light into different wavelengths before it reaches the double-slit arrangement, a screen or imaging detector positioned to capture the light passing through the double-slit arrangement, a processor configured to analyze the captured light patterns and subtract the ambient light background to highlight the laser radiation peaks and calculate incoming laser beam direction by its relative location to the center of the slit.

### BRIEF DESCRIPTION OF THE DRAWINGS

Further advantages of the invention will emerge from the following descriptions and drawings, which are provided as non-limiting example and in which:

FIG. 1 is a schematic description which displays a superposition of incoherent light and laser light passing through a double slit experiment.

FIG. 2 is a schematic description which displays the said light superposition when passing through a dispersive element in front of a double slit experiment.

FIG. 3 schematically shows the result of said light superposition on the screen or imaging detector.

### DETAILED DESCRIPTION OF THE DRAWINGS

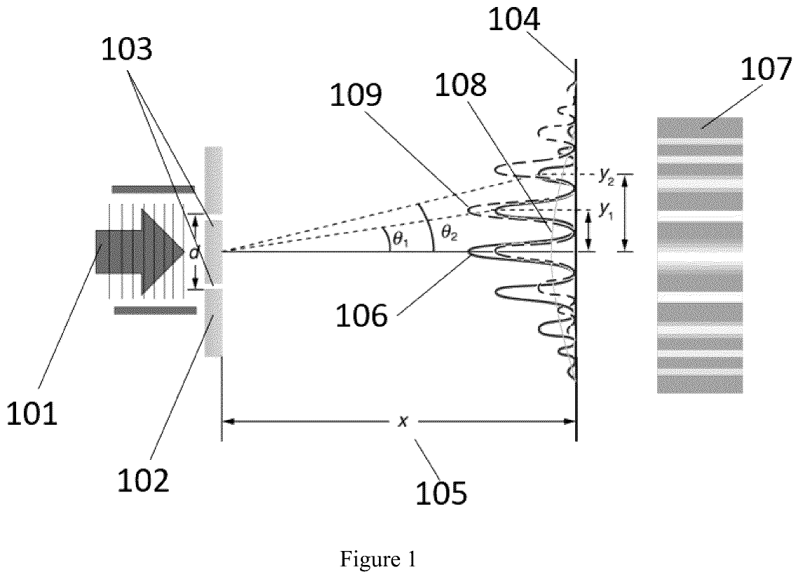

FIG. 1 depicts a cross-section of the proposed device for distinguishing laser radiation from ambient light. The device, exposed to a combination of laser radiation of an unknown wavelength and ambient light denoted by 101, projects this mixture onto an opaque surface 102. The light then passes through a double-slit arrangement 103. A screen or imaging detector 104, placed at a specific distance 105, displays the resulting pattern. The coherent laser radiation creates a distinct interference pattern with well-defined peaks and valleys 106, whereas the ambient light 108 results in a diffuse pattern. By processing the image from the detector, the ambient light's average value can be subtracted, enhancing the signal-to-noise ratio between the laser signal and the environment. The expected results are shown on the screen 107. If the incoming beam has an angle relative to a beam which is perpendicular to the double slit, then the interference pattern will move on the screen or imaging detector 104 according to the incoming beam direction. This movement is simulated in my drawing by a dotted line and it's denoted as 109.

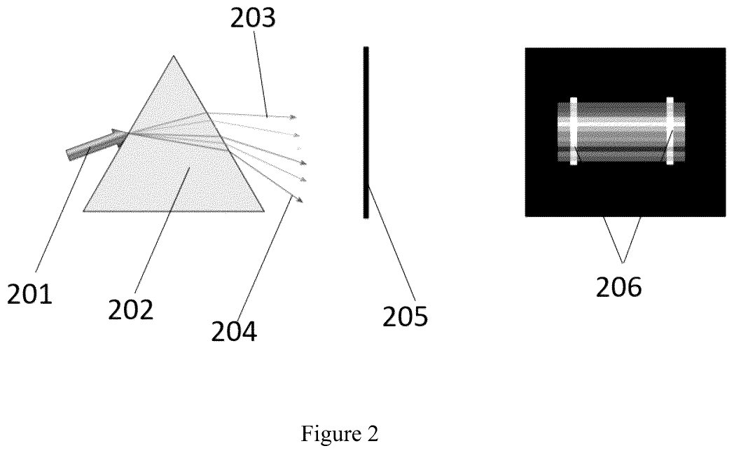

FIG. 2 illustrates another embodiment aimed at significantly reducing the effects of ambient light for improved signal discernment. Incoming light 201 passes through a dispersive element 202, which separates the light based on its wavelength, with long wavelengths represented by 203 and short wavelengths by 204. The dispersed laser radiation is then directed to a double-slit screen 205, with the two slits clearly shown as 206.

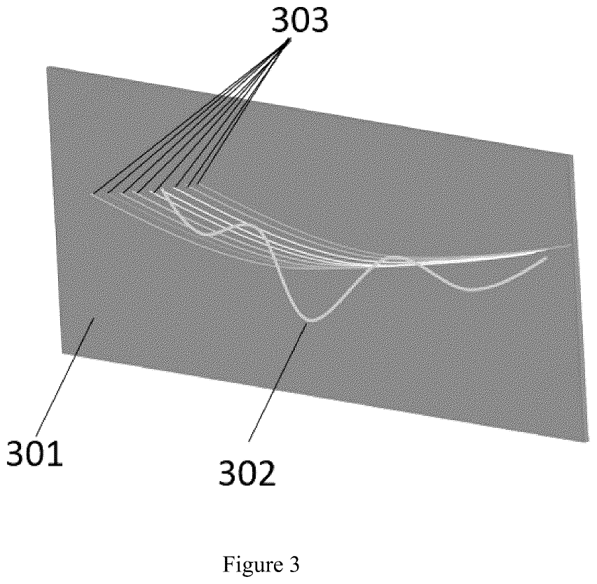

FIG. 3 shows a screen or imaging device positioned after the double-slit screen (205 in FIG. 2). Various wavelengths fan out on the screen surface 301, while the laser beam's diffraction pattern 302 remains unchanged, thereby increasing the signal-to-noise ratio between the laser diffraction peaks and the significantly spread-out non-coherent radiation 303.

1. An apparatus for distinguishing laser radiation from ambient light, comprising:
an opaque surface onto which a combination of laser radiation and ambient light is projected;
a double-slit arrangement positioned on said opaque surface;
a screen or imaging detector positioned at a predetermined distance from said double-slit arrangement; and
wherein the screen or imaging detector is configured to display an interference pattern for the laser radiation characterized by distinct peaks and valleys, and a diffuse pattern for the ambient light.

2. A method for enhancing the signal-to-noise ratio between laser radiation and ambient light, comprising:
projecting a combination of laser radiation and ambient light onto an opaque surface;
directing the light through a double-slit arrangement;
capturing the resulting interference and diffuse patterns on a screen or imaging detector; and
processing the captured image to subtract the average value of the ambient light, thereby enhancing the distinctness of the laser radiation peaks.

3. An apparatus for reducing the effect of ambient light on laser radiation detection, comprising:
a dispersive element configured to separate incoming light into components based on wavelength;
a double-slit screen positioned to receive the dispersed light;
a screen or imaging detector configured to capture the interference pattern of the laser radiation and the spread-out pattern of the ambient light; and
wherein the dispersive element enhances the signal-to-noise ratio by spreading out the ambient light while maintaining the coherence of the laser radiation.

4. A system for detecting laser radiation in high ambient light environments, comprising: an opaque surface for receiving combined laser radiation and ambient light;
a double-slit arrangement on the opaque surface;
a dispersive element for separating light into different wavelengths before it reaches the double-slit arrangement;
a screen or imaging detector positioned to capture the light passing through the double-slit arrangement; and
a processor configured to analyze the captured light patterns and subtract the ambient light background to highlight the laser radiation peaks and calculate incoming laser beam direction by its relative location to the center of the slit.
